(19) United States
(12) Patent Application Publication
(10) Pub. No.: US 2019/0104820 A1
(43) Pub. Date: Apr. 11, 2019

(54) MC PROFESSIONAL HAIRDRYER WITH SECURE ATTACHMENTS

(71) Applicant: Peggy A. Williams, San Jose, CA (US)

(72) Inventor: Peggy A. Williams, San Jose, CA (US)

(21) Appl. No.: 15/726,395

(22) Filed: Oct. 6, 2017

(51) Int. Cl. A45D 20/12; A45D 20/52

(52) U.S. Cl. CPC A45D 20/122; F16L 15/006; A45D 20/52

(57) ABSTRACT

An MC professional hairdryer has secure attachments. More specifically, hairdryer has interchangeable secure attachments which can be connected to the hairdryer in a secure manner so that they do not fall off or become separated during use. The hairdryer is also provided in combination with a hairdryer stand, so that the hairdryer can be supported in a position to facilitate attachment and removal of accessories for the hairdryer. Such accessories can include combs, cones for concentrating air flow, and diffuser attachment for spreading out the air flow, among others. The stand is configured such that the dryer can stand upright on its base, instead of being hung or laid down. The attachments, according to the present invention, are secured by threaded engagement with the hairdryer, such that they can be screwed on and off by a user.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to an MC professional hairdryer with secure attachments; and also relates to an MC professional hairdryer with secure attachments in combination with a base for supporting the hairdryer.

### BACKGROUND OF THE INVENTION

It is a problem in the art to provide a hairdryer with attachments which can be connected to the hairdryer in a secure manner so that they do not fall off or become separated during use.

It is also a problem in the art to provide a hairdryer in combination with a hairdryer stand, so that the hairdryer can be supported in a position adapted to facilitate attachment and removal of accessories for the hairdryer. Such accessories can include combs, cones for concentrating air flow, and diffuser attachment for spreading out the air flow, among others. All attachments which would be known to any one having skill in the hairdryer arts are contemplated as being within the scope of the present invention.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an MC professional hairdryer with secure attachments.

More specifically, the device of the present invention provides an MC professional hairdryer with secure attachments which can be connected to the hairdryer in a secure manner so that they do not fall off or become separated during use.

Further, the device of the present invention provides an MC professional hairdryer with secure attachments in combination with a hairdryer stand, so that the hairdryer can be supported in a position adapted to facilitate attachment and removal of accessories for the hairdryer. Such accessories can include combs, cones for concentrating air flow, and diffuser attachment for spreading out the air flow, among others. All attachments which would be known to any one having skill in the hairdryer arts are contemplated as being within the scope of the present invention.

The device of the present invention provides attachments which are interchangeable. The stand is configured such that the dryer can stand upright on its base, instead of being hung or laid down. The attachments, according to the present invention, are secured by threaded engagement with the hairdryer, such that they can be screwed on and off by a user.

Other objects and advantages of the present invention will be more readily apparent from the following detailed description when read in conjunction with the accompanying drawings.

### BRIEF DESCRIPTION OF THE DRAWINGS

FIG. 1 is a perspective view of an MC professional hairdryer with secure attachments, according to the invention.

FIG. 2 is an exploded perspective view of the device of FIG. 1.

FIG. 3 is a perspective view of another embodiment of the present invention, showing an MC professional hairdryer with secure attachments in combination with a base, according to the invention.

FIG. 4 is an exploded view of the embodiment of the present invention of FIG. 3, showing an MC professional hairdryer with secure attachments in combination with a base.

FIG. 5 is a side elevational view of an attachment having a securement end, for use with the MC professional hairdryer with secure attachments of FIG. 1, FIG. 2, FIG. 3, and FIG. 4.

FIG. 6 is a sectional view of the MC professional hairdryer with secure attachments of FIG. 1 and FIG. 3, taken along line 6-6 of FIG. 3.

FIG. 7 is schematic view of a motor, a power supply, and a fan connected to drive the fan.

### DETAILED DESCRIPTION OF THE INVENTION

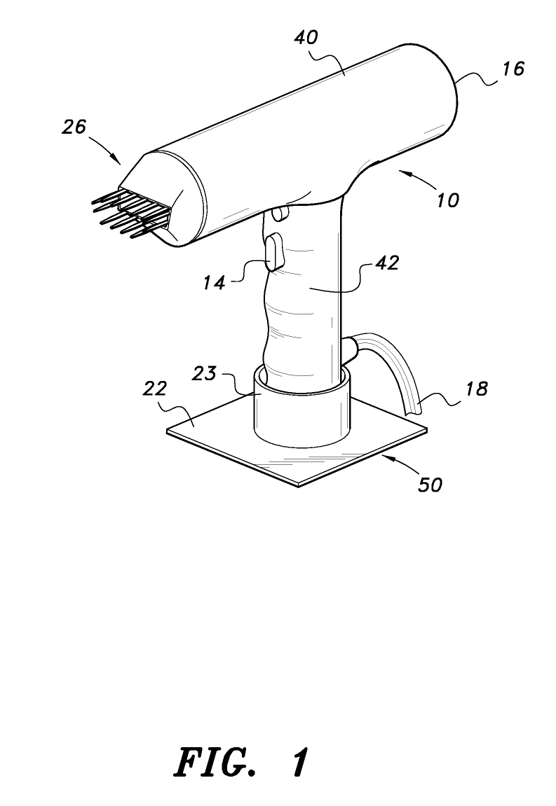

FIG. 1 is a perspective view of an MC professional hairdryer 10 with a secure attachment 26 mounted thereon. The MC professional hairdryer 10 includes an upper barrel-shaped portion 40 having an air inlet 16 serving as a vent, and includes an ON/OFF switch 14 to activating the hairdryer 10. The hairdryer 10 further includes a handle portion 42, which is hollow and contains wiring (unnumbered) for supplying power.

The switch 14 is a conventional type of switch, and any type of switch can be used which would be known to one having skill in the hairdryer arts or electrical switch arts. The switch 14 can be located in other locations besides the one shown; any such locations can be used which would be known to one having skill in the hairdryer arts or electrical switch arts.

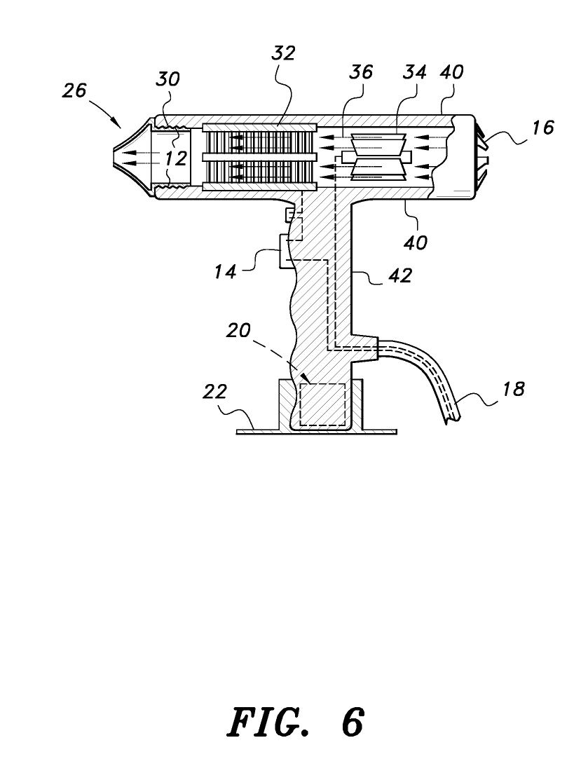

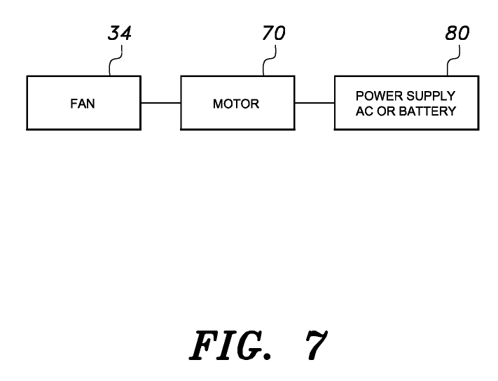

The upper barrel-shaped portion 40 is hollow, and contains a heater element 32 and a fan member 34 as shown in FIG. 6. The upper barrel-shaped portion 40 also contains a motor 70, which is a conventional element in hairdryers that is shown schematically in FIG. 7. The motor 70 can be located in the hairdryer 10 in any conventional manner that would be known by any one having skill in the hairdryer manufacturing arts.

The secure attachment 26 has a comb element at one end, and has a cone-shaped portion adjacent to the comb element for concentrating air flow exiting the upper barrel-shaped portion 40. Other types of secure attachments can be provided, which would be known to any one having skill in the hairdryer manufacturing arts.

The hairdryer 10 is supported in an upright position by a base 50 which has a flat portion 22 adapted to be supported by a flat surface, and a generally tubular portion 23 adapted to receive a lower end of the handle portion 42. In the preferred embodiment, the tubular portion 23 has a substantially circular cross section. Other cross sectional shapes can be used for the portion 23, such as oval, rectangular, hexagonal, and so on; in each case the base of the handle portion 42 would have a similar shape so that it can fit in a snug manner so as to retain the hairdryer 10 in an upright position when placed in the base 50.

A power cord 18 is shown extending from the handle portion 42, and is shown broken away on one end, the power cord 18 being a conventional one having a plug on one end (not shown). The power cord 18, in use, is connected to an electrical power supply such as a wall outlet. In an alternate embodiment, shown schematically in FIG. 6, the hairdryer 10 further includes a rechargeable battery 20.

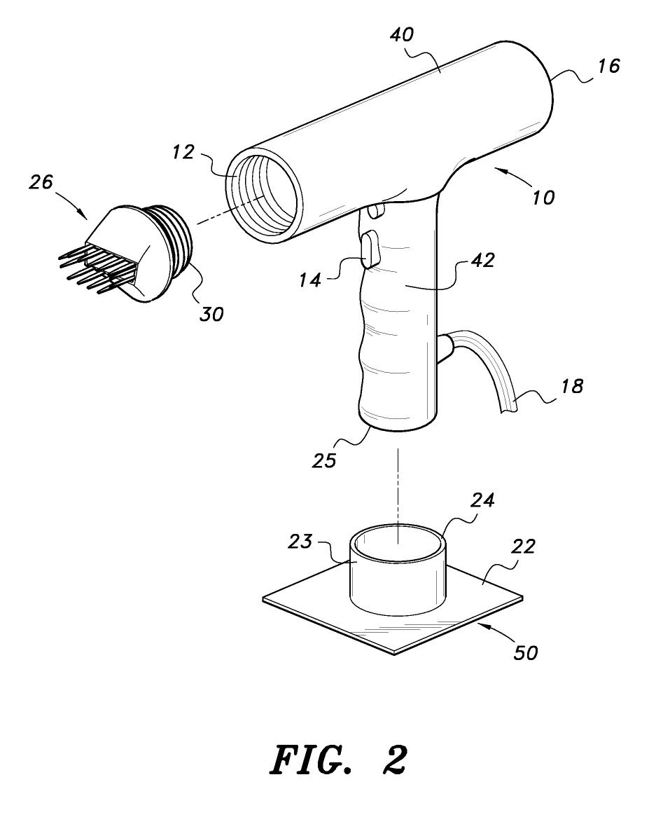

FIG. 2 is an exploded perspective view of the device of FIG. 1. The handle portion 42 has a bottom end 25 which is received in the base 50, the bottom end 25 being shaped to mate with the interior of the tubular portion 23. The tubular portion 23 has an uppermost edge 24. The secure attachment 26 has a male threaded portion 30. The upper barrel-shaped portion 40 has an interior female threaded portion 12 located on an opposite end of the hairdryer 10 from the vent 16. The interior female threaded portion 12 is adapted to engage the male threaded portion 23 in a conventional screw threaded engagement.

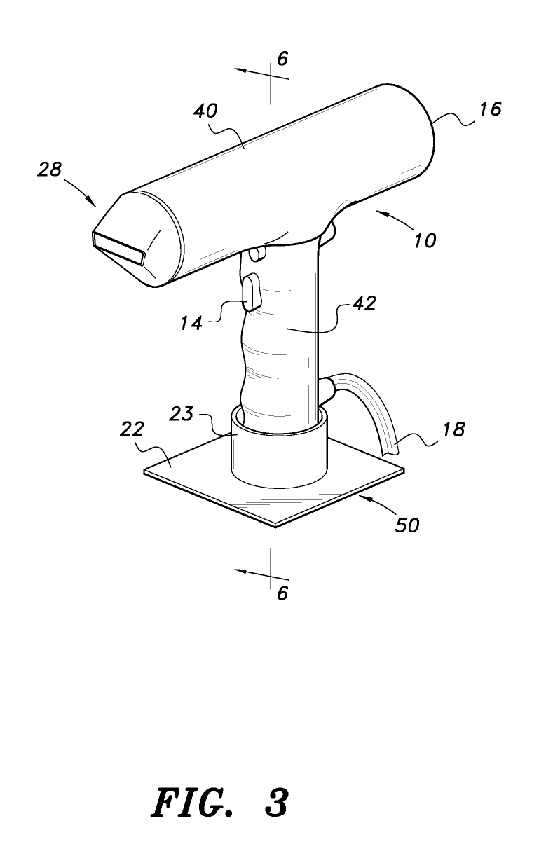

FIG. 3 is a perspective view of another embodiment of the present invention, showing the MC professional hairdryer 10 with a secure attachment 28, in combination with the base 50, according to the invention. In this view, lines 6-6 indicate where a sectional view is taken, and which is shown in FIG. 6. The secure attachment 28 is a cone attachment. Other types and shapes of cone attachments are also contemplated as being within the scope of the present invention.

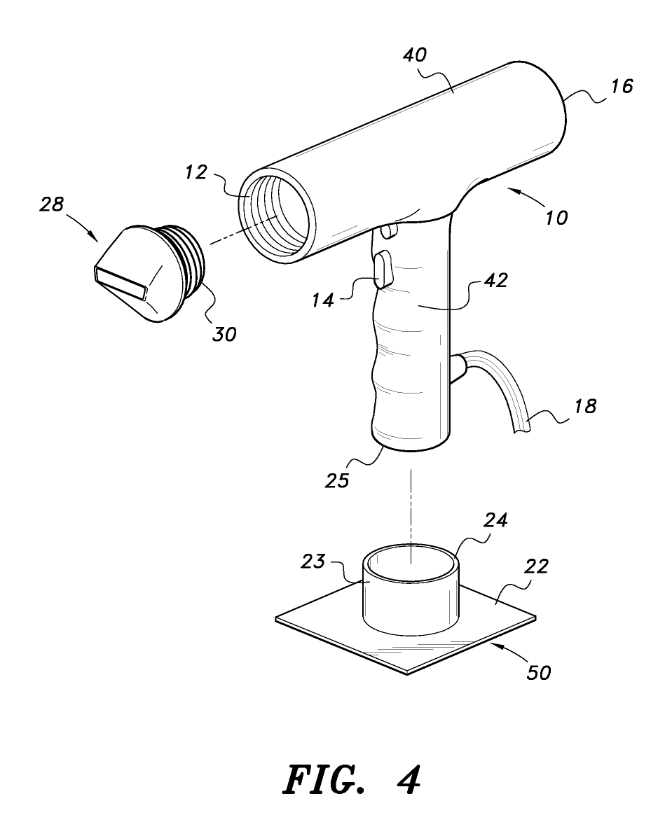

FIG. 4 is an exploded view of the embodiment of the present invention of FIG. 3, showing the MC professional hairdryer 10 with the secure attachment 28. Here, the secure attachment 28 has a male threaded portion 30, identical or similar to that shown in FIG. 2. The female threaded portion 12 is adapted to engage the male threaded portion 30 in a conventional screw threaded engagement.

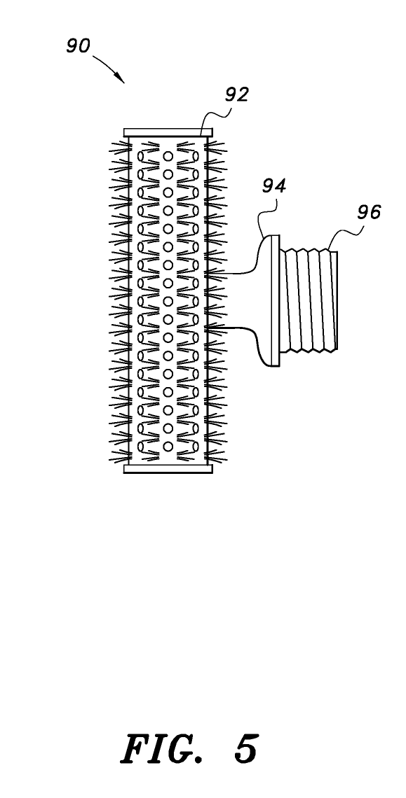

FIG. 5 is a side elevational view of another type of attachment 90, having a body 92 which is a brush attachment with holes for distributing air flow. The body 92 has an end 94 and a male threaded portion 96 similar to the male threaded portion shown in FIGS. 2 and 4, for mating in threaded engagement with the female threaded portion 12. The end 94 forms a shoulder, from which the portion 96 extends.

FIG. 6 is a sectional view of the MC professional hairdryer 10 taken along line 6-6 of FIG. 3. Wiring (not numbered) is shown in dashed outline, and a rechargeable battery 20 is shown schematically in dashed outline. The handle portion 42 is seated in the base 50. The upper barrel-shaped portion 40 has a fan 34 (schematically shown) and air flow is indicated by a plurality of arrows 36, indicating air flow from the vent 16 to the outlet end at the secure attachment 26. A heater element 32 is shown schematically as well.

The heater element 32 and the fan 34 can respectively be any type which would be known to any one having skill in the hairdryer manufacturing arts.

FIG. 7 is schematic view of a motor 70, a power supply 80 which can be an AC power supply and/or a rechargeable battery, and a fan 34 connected to drive the fan 34. These elements can be varied to include any such elements which would be known to any one having skill in the hairdryer manufacturing arts.

The present invention provides an MC professional hairdryer 10 with secure attachments which can be connected to the hairdryer 10 in a secure manner so that they do not fall off or become separated during use.

Further, the device of the present invention provides an MC professional hairdryer 10 with secure attachments in combination with a hairdryer stand or base 50, so that the hairdryer 10 can be supported in a position adapted to facilitate attachment and removal of accessories for the hairdryer. Such accessories can include combs, cones for concentrating air flow, and diffuser attachment for spreading out the air flow, among others. All attachments which would be known to any one having skill in the hairdryer arts are contemplated as being within the scope of the present invention.

The device of the present invention provides attachments which are interchangeable. The stand 50 is configured such that the hairdryer 10 can stand upright on its base, instead of being hung or laid down. The attachments, according to the present invention, are secured by threaded engagement with the hairdryer, such that they can be screwed on and off by a user.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A hairdryer for use with detachable attachments, comprising:
an upper barrel-shaped portion having an attachment end and an air inlet end, said air inlet end serving as a vent;
a fan mounted in said upper barrel-shaped portion for directing air flow from said air inlet end toward said attachment end;
a motor mounted in said upper barrel-shaped portion for driving said fan;
circuitry for connection to a power supply and to said motor, for providing power to drive said fan;
a handle portion connected to said upper barrel-shaped portion;
an ON/OFF switch mounted on said handle portion; said ON/OFF switch being connected to said circuitry to control operation of said motor;
said attachment end having an internal female threaded portion adapted to receive male threaded attachments; and
at least one manually detachable attachment having a male threaded end adapted for engagement with said female threaded portion of said attachment end; whereby the attachments are secured by threaded engagement with said upper barrel-shaped portion such that they can be screwed on and off manually by a user.

2. The hairdryer of claim 1, wherein said manually detachable attachment has a comb attachment.

3. The hairdryer of claim 1, wherein said manually detachable attachment has a cone attachment.

4. The hairdryer of claim 1, wherein said manually detachable attachment has a brush attachment.

5. A hairdryer for use with detachable attachments in combination with a support stand, comprising:
an upper barrel-shaped portion having an attachment end and an air inlet end, said air inlet end serving as a vent;
a fan mounted in said upper barrel-shaped portion for directing air flow from said air inlet end toward said attachment end;
a motor mounted in said upper barrel-shaped portion for driving said fan;
circuitry for connection to a power supply and to said motor, for providing power to drive said fan;
a handle portion connected to said upper barrel-shaped portion;
an ON/OFF switch mounted on said handle portion; said ON/OFF switch being connected to said circuitry to control operation of said motor;
said attachment end having an internal female threaded portion adapted to receive male threaded attachments;
a manually detachable attachment having a male threaded end adapted for engagement with said female threaded portion of said attachment end; and
a hairdryer support stand having a flat portion and a tubular portion; said tubular portion being adapted to receive a free end of said handle portion, so that said handle portion can be supported when not in use, and so that said handle portion can be supported in a position adapted to facilitate attachment and removal of accessories.

6. The hairdryer of claim 5, wherein said manually detachable attachment has a comb attachment.

7. The hairdryer of claim 5, wherein said manually detachable attachment has a cone attachment.

8. The hairdryer of claim 5, wherein said manually detachable attachment has a brush attachment.

9. The hairdryer of claim 5, wherein said upper barrel-shaped portion is composed of plastic.

10. The hairdryer of claim 5, wherein said upper barrel-shaped portion is composed of plastic.

11. The hairdryer of claim 1, wherein said upper barrel-shaped portion is an elongated hollow tubular body.

12. The hairdryer of claim 5, wherein said upper barrel-shaped portion is an elongated hollow tubular body.
